(19) United States
(12) Patent Application Publication
(10) Pub. No.: US 2022/0097175 A1
(43) Pub. Date: Mar. 31, 2022

(54) METHOD FOR EXTENDING SERVICE LIFE OF A SACRIFICIAL-LAYER-FREE ALUMINUM ALLOY WHEEL BY LASER SHOCK

(71) Applicant: CITIC Dicastal Co., Ltd., Qinhuangdao (CN)

(72) Inventors: Bowen Xue, Qinhuangdao (CN); Tieqiang Chen, Qinhuangdao (CN); Decai Kong, Qinhuangdao (CN); Yong Liu, Qinhuangdao (CN)

(73) Assignee: CITIC Dicastal Co., Ltd., Qinhuangdao (CN)

(21) Appl. No.: 17/389,468

(22) Filed: Jul. 30, 2021

(30) Foreign Application Priority Data
Sep. 30, 2020 (CN) 202011057208.9

(51) Int. Cl. B23K 26/356; B23K 26/0622

(52) U.S. Cl. CPC B23K 26/356; B23K 26/0622; B60B 2310/50; B23K 2103/10; B60B 2360/104; B60B 2900/321; B60B 2310/614

(57) ABSTRACT

Disclosed is a method for extending service life of a sacrificial-layer-free aluminum alloy wheel by laser shock, comprising: performing finite element analysis each position of the wheel under actual working conditions; connecting the to-be-peened wheel to a fixture on a robot; determining laser shock peening parameters; upon laser shock, performing cleaning treatment on the shocked wheel to remove surface ablating; and performing paint spraying treatment on the processed aluminum alloy wheel. The method provided by the present disclosure can not only improve surface hardness of the aluminum alloy wheel, but also form a residual compressive stress layer on a subsurface, thereby restraining crack propagation, prolonging the service life of an aluminum alloy wheel hub and improving stability of the hub.

### FIELD

The present disclosure relates to the technical field of aluminum alloy wheels, in particular to a method for extending service life of a sacrificial-layer-free aluminum alloy wheel by laser shock.

### BACKGROUND

Aluminum alloy hubs stand out in the automobile industry and have magnificent development potentials due to advantages of light weight, rapid heat dissipation, beautiful appearance, colorful patterns, precise dimensions, good balance, easy manufacturing, etc. However, aluminum alloy wheels are complex in structure and require severe working conditions, as a result, the wheels have lower stability and strength after being used for a long time, and even accidents occur to affect safety of properties and life of people. Laser shock peening as a novel surface strengthening technology can well prolong the service life of an aluminum alloy wheel. However, a sacrificial layer needs to be coated to protect a base body during machining and needs to be removed after machining, consequently machining efficiency of laser shock peening is greatly lowered, and the requirement for high production efficiency of wheels may not be met.

### SUMMARY

For this purpose, the present disclosure aims to provide a method for extending service life of a sacrificial-layer-free aluminum alloy wheel by laser shock, to solve the problem of low efficiency caused by coating and removing of a sacrificial layer during laser shock peening of an aluminum alloy wheel in prior art.

To make the objectives, the technical solution of the present disclosure is implemented as follows:

The method for extending service life of a sacrificial-layer-free aluminum alloy wheel by laser shock includes the following steps:

(1) determining to-be-peened positions of the wheel by performing finite element analysis of the stress condition of each position of the wheel under actual working conditions;

(2) connecting the wheel to a fixture on a robot, and generating a wheel motion path by off-line programming software;

(3) determining laser shock peening parameters, starting up the robot and laser devices, and controlling the wheel to move to be subjected to laser shock peening treatment;

(4) upon laser shock, moving the shocked surface of the wheel to a focus of a laser cleaner by the robot and performing cleaning treatment on the shocked wheel; and

(5) performing paint spraying treatment on the processed wheel.

In some embodiments, an ablating layer formed by laser shock is removed by a laser cleaning method.

In some embodiments, in the step (1), finite element analysis of the stress condition of each position is performed to determine the positions which are under a stress over 120 Mpa as to-be-peened positions.

In some embodiments, in the step (3), the laser shock peening parameters include: a laser wavelength of 1064 nm, a laser energy of 5-30 J, a pulse width of 10-20 ns, a repetition frequency of 2-10 Hz, a beam diameter of 2-5 mm, a distance between two adjacent light spots being 0.2-0.7 times of spot diameter, and shock times of 1-4.

In some embodiments, in the step (4), laser with a laser power of 50-200 w, a repetition frequency of 100-200 kHz, a scanning speed of 2000-10000 mm/s and a wavelength of 1064 nm is used for cleaning the ablating layer on the shocked surface for 1-4 times until surface ablation is removed.

In some embodiments, in the step (2), the wheel motion path is generated by the off-line programming software.

Compared with the prior art, the method for extending service life of a sacrificial-layer-free aluminum alloy wheel by laser shock of the present disclosure has the following advantages:

1. The method can improve surface hardness of the aluminum alloy wheel and form a residual compressive stress layer on a subsurface, thereby restraining crack propagation, prolonging service life of an aluminum alloy wheel hub and improving stability of the hub.

2. The ablating layer formed by laser shock on the surface is removed by the laser cleaning method, and thus the effect of laser shock peening and the appearance after laser shock peening are improved. Furthermore, due to the use of the laser cleaning process, the base body may be shocked for multiple times by high energy without considering the damage to the sacrificial layer, and then peening efficiency is improved.

3. The solution of laser shock of the aluminum alloy wheel is free from coating and removing of the sacrificial layer, and thus can greatly improve machining efficiency and reduce the cost of manpower and materials caused by the use of the sacrificial layer.

### BRIEF DESCRIPTION OF THE DRAWINGS

The accompanying drawing as one part of the present disclosure provides a further understanding of the present disclosure, and exemplary embodiments of the present disclosure and description thereof are provided to interpret the present disclosure, but not to improperly limit the present disclosure. In the accompanying drawing:

FIG. 1 is an operation procedure of a method for extending service life of a sacrificial-layer-free aluminum alloy wheel by laser shock of the present disclosure.

### DETAILED DESCRIPTION OF THE EMBODIMENTS

It should be noted that the embodiments of the present disclosure and features in the embodiments may be combined with each other under no conflicts.

The technical solutions of the present disclosure will be clearly and comprehensively described as below by reference to the accompanying drawing in conjunction with the embodiments. Obviously, the embodiments as described herein are only part of the embodiments of the present disclosure, but not to represent all the embodiments. All other embodiments that those of ordinary skill in the art may acquire without making creative efforts all belong to the protection scope of the present disclosure.

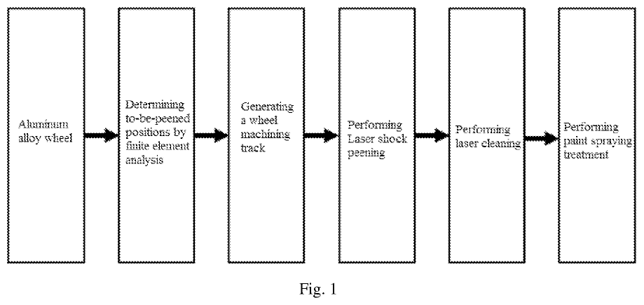

By reference to FIG. 1, a method for extending service life of a sacrificial-layer-free aluminum alloy wheel by laser shock of the embodiments of the present disclosure is described in conjunction with the embodiments as below.

The method for extending service life of a sacrificial-layer-free aluminum alloy wheel by laser shock includes the following steps:

1, with respect to the wheel of a specific shape, performing finite element analysis of the stress condition of each position under actual working conditions, and peening the positions which are under a stress over 120 Mpa;

2, connecting the to-be-peened wheel to a fixture on a robot, and generating a wheel motion path by off-line programming software; and using the robot to control the initial position of a to-be-peened area of the wheel to move to a laser focus, and applying a layer of water film with a thickness in the range of 0.5-2 mm on the focus by a nozzle;

3, starting up a laser device 1, and using laser with a wavelength of 1064 nm, a laser energy of 5-30 J, a pulse width of 10-20 ns, a repetition frequency of 2-10 Hz and a beam diameter of 2-5 mm; and starting up the robot to control the wheel to move until a distance between two adjacent light spots is 0.2-0.7 times of spot diameter and then to let the wheel be under shock for 1-4 times;

4, after laser shock, moving the shocked surface of the wheel to a focus of a laser cleaner by the robot and performing cleaning treatment on the shocked wheel;

5, starting up a laser device 2, and using laser with a laser power of 50-200 w, a repetition frequency of 100-200 kHz, a scanning speed of 2000-10000 mm/s and a wavelength of 1064 nm for cleaning the ablating layer on the shocked surface for 1-4 times until surface ablation is removed; and

6, performing paint spraying treatment on the processed aluminum alloy wheel.

### Embodiment 1

(1) as illustrated in FIG. 1, with respect to an A356.2 casting aluminum alloy wheel, performing finite element analysis of the stress condition of each position under actual working conditions, and taking a sample down from the positions which are under a stress over 120 Mpa;

(2) connecting the to-be-peened sample to a fixture on a robot, and generating a wheel sample motion path by off-line programming software; and using the robot to control the initial position of a to-be-peened area of the wheel to move to a laser focus, and applying a layer of water film with a thickness of 1 mm on the focus by a nozzle;

(3) starting up a laser device 1, and using laser with a wavelength of 1064 nm, a laser energy of 10 J, a pulse width of 15 ns, a repetition frequency of 5 Hz and a beam diameter of 3 mm; and starting up the robot to control the wheel to move until a distance between two adjacent light spots is 0.6 times of spot diameter and then to let the wheel be under shock for 2 times;

(4) after laser shock, with respect to an ablation layer on the surface, moving the shocked surface of the wheel to a focus of a laser cleaner by the robot and performing cleaning treatment on the shocked wheel;

(5) starting up a laser device 2, and using laser with a laser power of 100 w, a repetition frequency of 150 kHz, a scanning speed of 6000 mm/s and a wavelength of 1064 nm for cleaning the ablating layer on the shocked surface for 2 times until the surface shows primary metal color; and

(6) performing paint spraying treatment on the processed aluminum alloy wheel.

To compare manipulated peening effects before and after laser shock of the aluminum alloy wheel under shock or no shock, the present disclosure further takes tests on microhardness of the wheel, and test results are shown in Table below. It can be known from Table 1 that the surface hardness of the wheel after peening is improved.

TABLE 1

| | Microhardness |
|---|---|
| Before Peening | 95.30 |
| After Peening | 118.71 |

### Embodiment 2

(1) with respect to an A356.2 casting aluminum alloy wheel, performing finite element analysis of the stress condition of each position under actual working conditions, and peening the positions which are under a stress over 120 Mpa;

(2) connecting the to-be-peened wheel to a fixture on a robot, and generating a wheel motion path by off-line programming software; and using the robot to control the initial position of a to-be-peened area of the wheel to move to a laser focus, and applying a layer of water film with a thickness of 2 mm on the focus by a nozzle;

(3) starting up a laser device 1, and using laser with a wavelength of 1064 nm, a laser energy of 20 J, a pulse width of 20 ns, a repetition frequency of 5 Hz and a beam diameter of 5 mm; and starting up the robot to control the wheel to move until a distance between two adjacent light spots is 0.5 times of spot diameter and then to let the wheel be under shock for 4 times;

(4) after laser shock, moving the shocked surface of the wheel to a focus of a laser cleaner by the robot and performing cleaning treatment on the shocked wheel;

(5) starting up a laser device 2, and using laser with a laser power of 200 w, a repetition frequency of 100 kHz, a scanning speed of 8000 mm/s and a wavelength of 1064 nm for cleaning the ablating layer on the shocked surface for 4 times; and

(6) performing paint spraying treatment on the processed aluminum alloy wheel.

To compare peening effects before and after laser shock of the aluminum alloy wheel under shock or no shock, the present disclosure further takes tests on microhardness of the wheel, and test results are shown in Table below. It can be known from Table 2 that the surface hardness of the wheel after peening is improved.

TABLE 2

| | Microhardness |
|---|---|
| Before Peening | 99.70 |
| After Peening | 110.82 |

Compared with the prior art, the method for extending service life of a sacrificial-layer-free aluminum alloy wheel by laser shock of the present disclosure has the following advantages:

1. The method can improve surface hardness of the aluminum alloy wheel and form a residual compressive stress layer on a subsurface, thereby restraining crack propagation, prolonging service life of an aluminum alloy wheel hub and improving stability of the hub.

2. The ablating layer formed by laser shock on the surface is removed by the laser cleaning method, and thus the effect of laser shock peening and the appearance after laser shock peening are improved. Furthermore, due to the use of the laser cleaning process, the base body may be shocked for multiple times by high energy without considering the damage to the sacrificial layer, and then peening efficiency is improved.

3. The solution of laser shock of the aluminum alloy wheel is free from coating and removing of the sacrificial layer, and thus can greatly improve machining efficiency and reduce the cost of manpower and materials caused by the use of the sacrificial layer.

What is claimed is:

1. A method for extending service life of a sacrificial-layer-free aluminum alloy wheel by laser shock, wherein the method comprises the steps of:
(1) determining to-be-peened positions of the wheel by performing finite element analysis of the stress condition of each position of the wheel under actual working conditions;
(2) connecting the wheel to a fixture on a robot, and generating a wheel motion path;
(3) determining laser shock peening parameters, starting up the robot and laser devices, and controlling the wheel to move to be subjected to laser shock peening treatment;
(4) after laser shock, moving the shocked surface of the wheel to a focus of a laser cleaner by the robot, and performing cleaning treatment of the shocked wheel; and
(5) performing paint spraying treatment on the processed wheel.

2. The method for extending service life of a sacrificial-layer-free aluminum alloy wheel by laser shock according to claim 1, wherein an ablating layer formed by laser shock is removed by a laser cleaning method.

3. The method for extending service life of a sacrificial-layer-free aluminum alloy wheel by laser shock according to claim 1, wherein in the step (1), performing finite element analysis of the stress condition of each position and determining the positions which are under a stress over 120 Mpa as to-be-peened positions.

4. The method for extending service life of a sacrificial-layer-free aluminum alloy wheel by laser shock according to claim 1, wherein in the step (3), the laser shock peening parameters comprise: a laser wavelength of 1064 nm, a laser energy of 5-30 J, a pulse width of 10-20 ns, a repetition frequency of 2-10 Hz, a beam diameter of 2-5 mm, a distance between two adjacent light spots being 0.2-0.7 times of spot diameter, and shock times of 1-4.

5. The method for extending service life of a sacrificial-layer-free aluminum alloy wheel by laser shock according to claim 1, wherein in the step (4), laser with a laser power of 50-200 w, a repetition frequency of 100-200 kHz, a scanning speed of 2000-10000 mm/s and a wavelength of 1064 nm being used for cleaning an ablating layer on the shocked surface for 1-4 times until the ablating layer on the shocked surface is removed.

6. The method for extending service life of a sacrificial-layer-free aluminum alloy wheel by laser shock according to claim 1, wherein in the step (2), the wheel motion path is generated by the off-line programming software.
